(19) United States
(12) Patent Application Publication
(10) Pub. No.: US 2008/0143549 A1
(43) Pub. Date: Jun. 19, 2008

(54) ELECTRICALLY EXCITED POSTER

(75) Inventors: John K. Grosspietsch, Libertyville, IL (US); Timothy J. Collins, Homer Glen, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/611,202

(22) Filed: Dec. 15, 2006

(51) Int. Cl. G09F 13/00; G09F 13/20

(52) U.S. Cl. 340/815.53; 340/825.22

(57) ABSTRACT

A method and system for controlling an electrically excited poster 100 is presented. In a preferred embodiment, the poster 100 comprises a plurality of embedded illumination circuits 104; and a hard-wired Display Code Storage Unit (DCSU) 106, wherein the hard-wired DCSU 106 outputs a display code that controls an illumination pattern that has been pre-determined for the embedded illumination circuits 104.

### BACKGROUND OF THE INVENTION

The present invention relates in general to the field of posters and like devices. More particularly, the present invention relates to posters and like devices that utilize embedded illumination circuits.

New technologies allow posters, which are usually made of cellulose or similar fibrous and/or other flexible materials, to be illuminated by electrically exciting embedded illumination circuits. These embedded circuits illuminate the poster in a manner that allows the poster to be read in low-light environments, and/or to create a noticeable appearance to attract a viewer's attention. Different posters often need to have their illumination circuits activated in a particular sequence that comports with an overall aesthetic design of the poster.

Drive electronics, for the illumination circuits, are typically not part of the poster, but rather are integral to a poster frame to which the poster is mounted. Therefore, every time a new poster is mounted on the poster frame, the drive electronics must be manually reprogrammed to properly illuminate the poster. This is time consuming, error prone, and requires a poster installer to have the technical skills required to reprogram the drive electronics.

### SUMMARY OF THE INVENTION

In recognition of the above described problem, the present invention is directed to a method and system for controlling an electrically excited poster. In a preferred embodiment, the poster comprises a plurality of embedded illumination circuits; and a hard-wired Display Code Storage Unit (DCSU), wherein the hard-wired DCSU outputs a display code that controls an illumination pattern that has been pre-determined for the embedded illumination circuits.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an inventive poster, having a hard-wired Display Code Storage Unit (DCSU), mounted in a poster frame;

FIG. 2 illustrates the DCSU utilizing diodes to program the DCSU;

FIG. 3 depicts a logic table of a display code output from the DCSU;

FIG. 4 illustrates a sequence of transmissions of a display code from the DCSU to a decoder, a display instruction from the decoder to a light driver, and a lighting sequence instruction from the light driver to embedded illumination circuits in the inventive poster;

FIG. 5 is an alternate embodiment of the DCSU that uses multiple groups of control lines from the decoder to the DCSU; and

FIG. 6 is a flow-chart of exemplary steps taken by the present invention to control the illumination of the embedded illumination circuits in the inventive poster.

### DETAILED DESCRIPTION OF THE PREFERRED EMBODIMENT

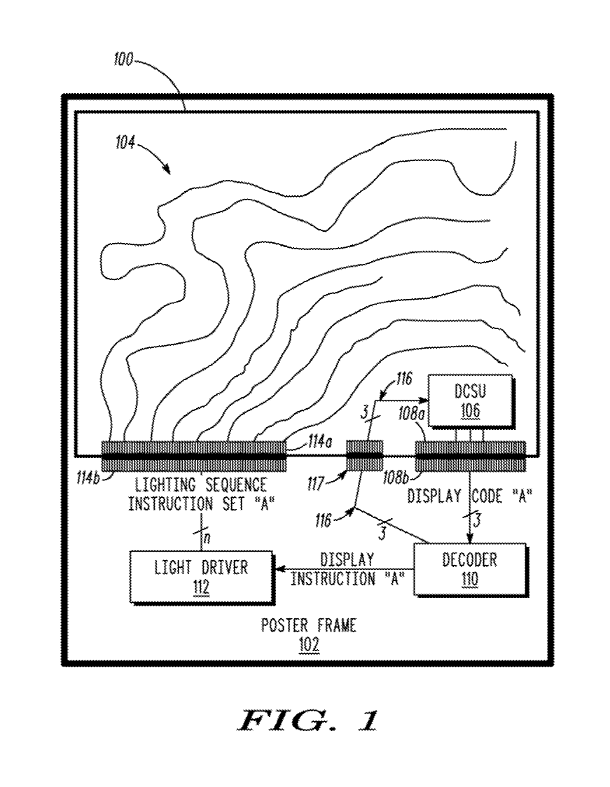

With reference now to the figures, and in particular to FIG. 1, an exemplary poster 100 is illustrated in accordance with the present invention. Poster 100 is removably electrically coupled to a poster frame 102, in a manner that is described in more detail below. Embedded within poster 100 is a plurality of embedded illumination circuits 104. The embedded illumination circuits 104 are light-emitting (preferably flexible) materials that produce light when an electrical voltage and/or current are applied. Examples of materials that make up the embedded illumination circuits 104 include, but are not limited to, Organic Light Emitting Diodes (OLEDs), polymer light emitting materials (including Polymer Light Emitting Diodes—PLEDs), crystalline thin films (e.g., acridine orange and quinacrine), Alternating Current (AC) driven electroluminescent cells (e.g., doped anthracene), etc.

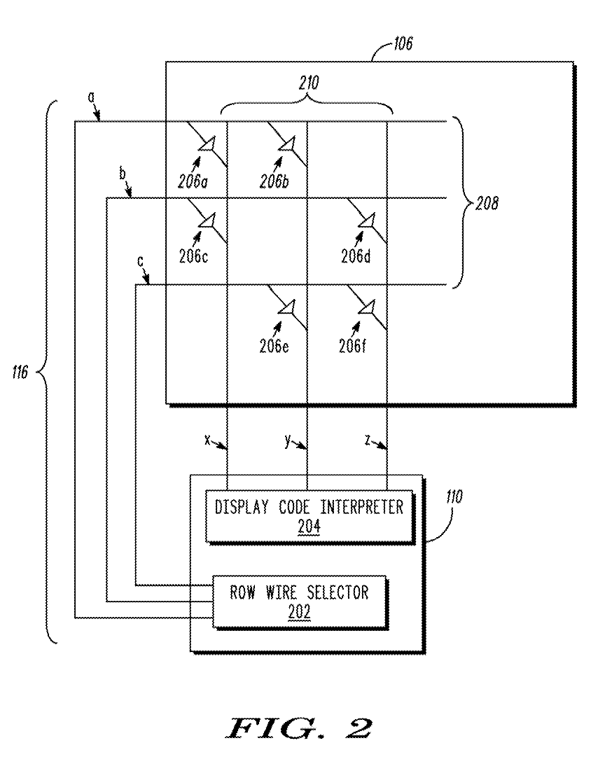

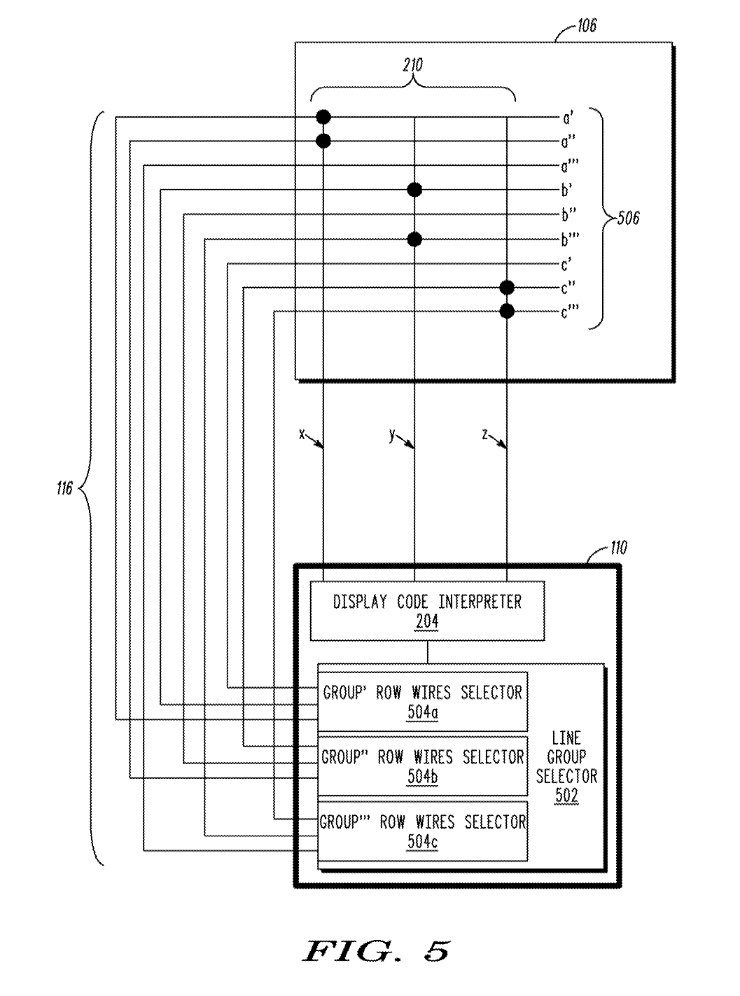

Also embedded with poster 100 is a Display Code Storage Unit (DCSU) 106, which stores display codes in a manner that is described in further detail below. DCSU 106 includes hard-wired logic that stores a display code. This stored display code is used by logic (described in exemplary detail below) in poster frame 102 to properly illuminate the illumination circuits in the plurality of embedded illumination circuits 104. In a preferred embodiment, DCSU 106 is printed on a surface (exterior and/or interior) of poster 100, using printing any technique that permits electrically conducting material to be printed directly onto the poster 100 in a pre-defined pattern. Alternatively, DCSU 106 may be fabricated using any other method in which a flexible circuit pattern can be affixed to the poster 100. Exemplary methods include, but are not limited to, circuit “sandwiching” (in which a flexible circuit is secured between layers of non-conducting poster material); embossing (in which the conductive circuit is printed and embossed on the non-conducting poster material); nanotube technology (in which conducting carbon nanotubes, which form the required DCSU 106 circuitry, are integrated into the non-conducting fabric of the poster 100), etc. DCSU 106 is electrically and removably coupled to a decoder 110, which is part of the poster frame 102, via a poster-side display code coupler 108a and a frame-side display code coupler 108b, which together are referred to as a display code coupler. In an exemplary manner, three electrical vertical lines are shown coming out of DCSU 106 and going into decoder 110. Note that the number of electrical lines coming out of DCSU 106 may be any so desired according to the design of the DCSU 106 and technical limitations thereon. Coming out of decoder 110 are control lines 116, which are depicted as row wires in FIG. 2 and FIG. 5. Control lines 116 control how display code information is read out of DCSU 106, and are coupled between decoder 110 and DCSU 106 by a control line coupler 117, which has a frame-side and a poster-side similar to that described for display code coupler 108(a-b). In an alternate embodiment, control lines 116 are coupled from decoder 110 and DCSU 106 via additional pins in display code coupler 108. As depicted in FIG. 1, there are three controls lines 116, which comports with FIG. 2. Alternatively, there may be more or fewer control lines 116, such as the nine control lines 116 shown in FIG. 5.

Decoder 110 decodes the display code received from DCSU 106 to generate a display instruction, which is transmitted to a light driver 112. The display instruction may be generated through the use of a look-up table that is available to the decoder 110, through hardwired logic (including an Application Specific Integrated Circuit—ASIC), or through any other means for decoding known to those skilled in the art. The display instruction is used by the light driver 112 to generate a lighting sequence instruction set, which is sent to the plurality of embedded illumination circuits 104 via a frame-side light driver coupler 114b and a poster-side light driver coupler 114a (collectively referred to as a light driver coupler). The lighting sequence instruction set may be generated though the use of a look-up table that is available to the light driver 112, through hardwired logic such as an ASIC, or through any other like means known to those skilled in the art. The lighting sequence instruction set is preferable transmitted to the plurality of illumination circuits 104 through a plurality of electrical lines whose number is the same as the number of illumination circuits found in plurality of embedded illumination circuits 104. Thus, the lighting sequence instruction set is defined as a unique set of electrical signals transmitted to specific pins in the light driver coupler, which result in the illumination of specific illumination circuits in the plurality of embedded illumination circuits 104 in a pre-defined manner.

With reference now to FIG. 2, additional detail is provided for an exemplary DCSU 106. Within DCSU 106 are column wires 210 (wires “x,” “y” and “z”) and row wires 208 (wires “a,” “b” and “c”). Except where shown as being coupled by a diode 206, the intersections of wires in the column wires 210 and the row wires 208 are initially electrically insulated. A row wire selector 202 selects an individual row wire (e.g., “a”) and electrically charges that wire. In the example shown, this causes current to flow through diodes 206a and 206b, resulting in a current in column wires “x” and “y.” Next, row wire selector 202 sends a current through row wire “b,” which results in current flowing through diodes 206c and 206d, thus causing a current in column wires “x” and “z.” Finally, row wire selector 202 sends a current through row wire “c,” resulting in current to flow through diodes 206e and 206f (and thus column wires “y” and “z”). Note that the diodes 206 are configured such that current from one row wire is not able to pollute other row wires. For example, when current flows through row wire “a,” the current flowing down column wire “x” is not able to flow past diode 206c to pollute wire row “b.”

The described current flows through column wires 210 into a display code interpreter 204 in decoder 110. Display code interpreter 204 is able to interpret (through a look-up table, hardware circuitry, etc.) the signals (Hi/Lo) coming from the wire columns 210, and to generate a display instruction (described above in FIG. 1).

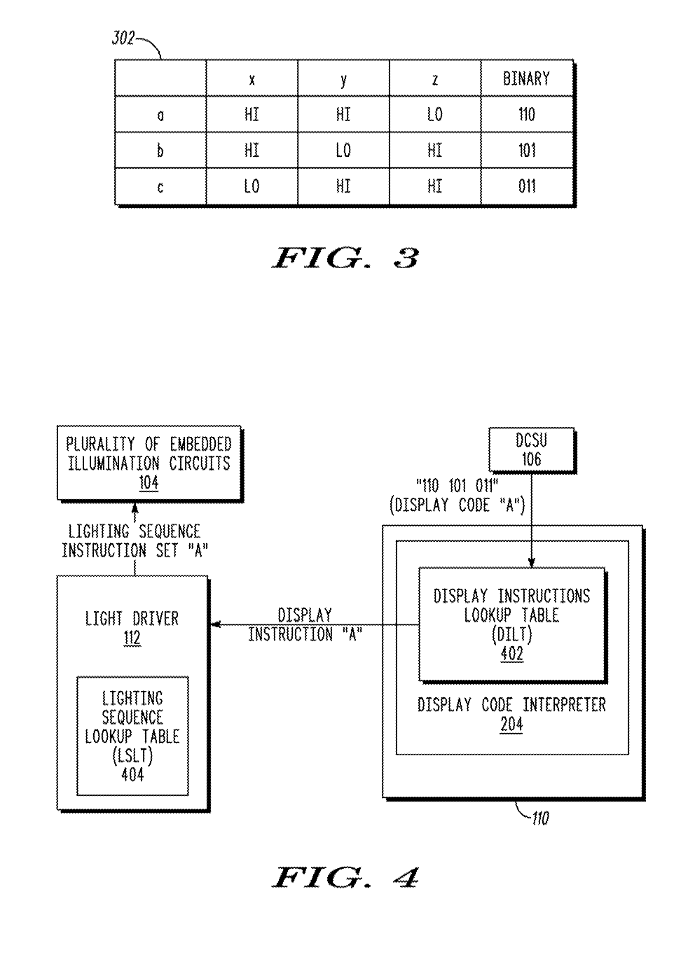

Continuing with the example shown in FIG. 2, reference is now made to FIG. 3, which shows a logic table 302 of signals (Hi/Lo) that were generated using the DCSU 106 shown in FIG. 2. As shown, row wire “a” causes column wires “x” and “y” to go Hi, while column wire “z” remains Lo. Display code interpreter 204 (shown in FIG. 2) understands this sequence as “110”. Similarly, row wire “b” causes “101” to be generated, and row wire “c” causes “011” to be generated. This sequence of binary numbers (“110 101 011”) is then sent to decoder 110, and more specifically to display code interpreter 204. In one embodiment, the sequence of binary numbers is directed to a Display Instructions Lookup Table (DILT) 402, as shown in FIG. 4. DILT 402 contains multiple Display Instructions (not shown). DILT 402, using the sequence “111 001 011”, is able to reference and select a specific Display Instruction “A”, which is required by the poster in which DCSU 106 is embedded. Display Instruction “A” is then sent to the light driver 112.

In a preferred embodiment, light driver 112 has access to a Lighting Sequence Lookup Table (LSLT) 404, which has multiple stored lighting sequences (not shown). Using the Display Instruction “A”, LSLT 404 is able to produce a lighting sequence instruction set “A”, which is used to properly illuminate the illumination circuits in the plurality of embedded illumination circuits 104. Alternatively, light driver 112 can use a hard-wired logic (e.g., an ASIC or a more simply circuit) to convert the Display Instruction “A” into a lighting sequence instruction set “A.”

With reference now to FIG. 5, an alternative DCSU 106 is presented. Rather than using diodes 206 as depicted in FIG. 2, the DCSU 106 shown in FIG. 5 has wires from column wires 210 directly connected in a selective manner to different wires in the row wires 506. Note that instead of the three control row wires 116 (“a” “b” “c”) shown in FIG. 2, the DCSU 106 shown in FIG. 5 has three sets of control row wires 116 ((a′ b′ c′) (a″ b″ c″) (a′″ b′″ c′″)). Each set of row wires is selected by a group row wires selector 504 in wire group selector 502 in decoder 110. For example, group′ row wire selector 504a sequentially sends a current through a′, b′ and c′, resulting in “110” as above in FIG. 2. However, unless intentionally coupled, other row wires in other groups (group″ and group′″) are unaffected by the current flowing through the group′ control row wires. Thus, the DCSU 106 shown in FIG. 5 generates the same binary code as the DCSU 106 shown in FIG. 2 (“110 101 011”), which is used by display code interpreter 204 in a similar manner as describe above in FIG. 4. Note that the functionality of the row wires 506 and control row wires 116 may be interchanged. That is, a current may be applied to column wires 210 such that a resulting voltage is detected on row wires 506. Note also that, instead of applying a current, a voltage may be applied with appropriate modifications (e.g., inserting an appropriately sized and placed resister) known to those skilled in the art.

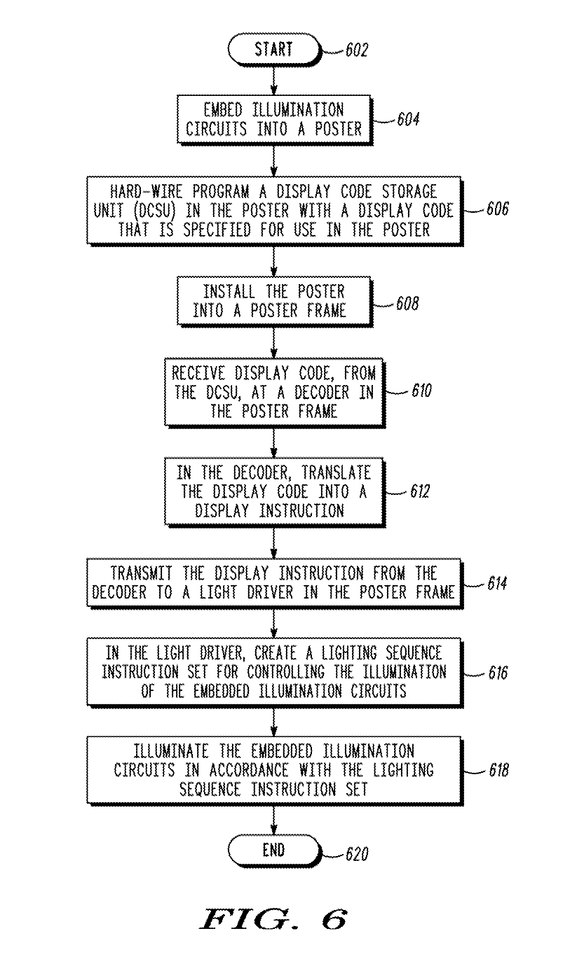

Referring now to FIG. 6, a flow-chart of exemplary steps taken to control the illumination of embedded illumination circuits in a poster are shown. After initiator block 602, which may be prompted by a manufacturing of a poster, illumination circuits are embedded in the poster (block 604). As described above, the illumination circuits may be composed of any material that emits light when electrically stimulated. During fabrication of the poster (which is preferably a cellulose material or similar flexible material), the Display Code Storage Unit (DCSU) is hare-wire programmed (block 606) with a display code that can be interpreted by a decoder in the poster frame. This display code is preferably unique for a lighting sequence or appearance desired by the designer of the poster.

Next, the poster is installed into a poster frame (block 608), through the use of light driver coupler 114, display code coupler 108 and control line coupler 117 shown in FIG. 1. The decoder is now able to query the DCSU for the display code (block 610), which is decoded (translated) to create a display instruction (block 612). This display instruction is then transmitted to the light driver (block 614), which creates a lighting sequence instruction set (block 616). This lighting sequence instruction set describes (or is the actual) electrical signals used to illuminate the embedded illumination circuits (block 618). The lighting sequence instruction set may be a pre-defined sequence of illumination of the embedded illumination circuits, or, alternatively, the lighting sequence instruction set may be a random illumination of the embedded illumination circuits. The process ends at terminator block 620.

It should be understood that at least some aspects of the present invention may alternatively be implemented in a computer-useable medium that contains a program product. Programs defining functions of the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

As described above, as presented herein are a poster, poster frame and method for controlling the illumination of a poster that has a plurality of embedded illumination circuits. In a preferred embodiment, the poster includes a hard-wired Display Code Storage Unit (DCSU), wherein the hard-wired DCSU outputs a display code that controls an illumination pattern that has been pre-determined for the embedded illumination circuits. In one embodiment, the poster also includes a display code coupler that electrically and removably couples the hard-wired DCSU to a decoder, wherein the decoder interprets the display code to select a specified display instruction from a plurality of display instructions that are stored in the decoder, and wherein the specified display instruction has been pre-determined for the embedded illumination circuits; and a light driver coupler, wherein the light driver coupler electrically and removably couples the embedded illumination circuits to a light driver, wherein the light driver receives, from the decoder, the specified display instruction for controlling the illumination pattern of the embedded illumination circuits. Preferably, the light driver and decoder are permanently installed in a poster frame to which the poster is removably coupled.

In one embodiment, the hard-wired DCSU further comprises: a plurality of wire columns; a plurality of wire rows, wherein intersections between wires in the wire columns and wire rows are initially electrically insulated, and wherein each row wire in the plurality of wire rows independently sends a query control signal to the wire columns; and at least one diode that is selectively electrically connected between a specified row wire in the wire rows and a specified column wire in the wire columns, wherein non-selected wires in wire columns and wire rows remain electrically insulated, and wherein query control signals independently cause unique connector information, between the wire rows and the wire columns, to be obtained from the wire columns. In another embodiment, the hard-wired DCSU further comprises: a plurality of wire columns; a plurality of wire rows, wherein intersections between wires in the wire columns and wire rows are initially electrically insulated, and wherein the plurality of wire rows are grouped into selectable groups that each independently send a query control signal to the wire columns; and at least one intersection connector that is selectively connected between a specified row wire in the wire rows and a specified column wire in the wire columns, wherein non-selected wires in wire columns and wire rows remain electrically insulated, and wherein each selectable group causes unique connector information, between the wire rows and the wire columns, to be obtained from the wire columns.

In an exemplary embodiment of the present invention, the poster is composed of paper, and the embedded electrical circuits are flexible circuits that illuminate when subjected to electricity. The illumination pattern for the embedded electrical circuits may be a random illumination of different embedded illumination circuits or a pre-defined sequence of illumination of the embedded illumination circuits.

In another embodiment of the present invention, a method is presented for illuminating a poster that has a plurality of embedded illumination circuits, wherein the method comprises the steps of: receiving a display code at a decoder, wherein the display code has been hard-coded in a hard-wired Display Code Storage unit (DCSU) in the poster; in the decoder, translating the display code into a display instruction; transmitting the display instruction to a light driver; in the light driver, creating a lighting sequence instruction set for the plurality of embedded illumination circuits, wherein the lighting sequence is controlled by the display instruction; and illuminating the embedded illumination circuits in accordance with the lighting sequence instruction set. In this method, the decoder and the light driver are preferably permanently installed in a poster frame to which the poster is removably connected, and the poster and the poster frame are electrically and removably coupled by a light driver coupler and a display code coupler, wherein the light driver coupler electrically couples the light driver to the plurality of embedded illumination circuits, and wherein the display code coupler electrically couples the hard-wired DCSU to the decoder.

In another embodiment of the present invention, a poster frame is presented in which the poster frame comprises: a decoder, wherein the decoder receives a display code from a hard-wired Display Code Storage Unit (DCSU) that is embedded in a poster, said poster being removably and electrically coupled to the poster frame, and wherein the decoder translates the display code into a display instruction; and a light driver, wherein the light driver is electrically coupled to a plurality of embedded illumination circuits in the poster, wherein the light driver creates a lighting sequence, for the plurality of embedded illumination circuits, that is controlled by the display instruction. Preferably, the hard-wired DCSU includes wire columns and wire rows, and wherein the decoder further comprises a row line selector that selectively signals a line in a row line to interrogate the wire rows for connections between wires in the wire columns and wires in the wire rows.

While the present invention has been particularly shown and described with reference to a preferred embodiment, it will be understood by those skilled in the art that various changes in form and detail may be made therein without departing from the spirit and scope of the invention. For example, while the term “row” and “column” have been used to illustrate a relationship between control wires and information wires in the hard-wired DCSU, the terms “row” and “column” should not be construed as being limited to only “row” and “column” orientations.

What is claimed is:

1. A poster comprising:
a plurality of embedded illumination circuits; and
a hard-wired Display Code Storage Unit (DCSU), wherein the hard-wired DCSU outputs a display code that controls an illumination pattern that has been pre-determined for the embedded illumination circuits.

2. The poster of claim 1, further comprising:
a display code coupler that electrically and removably couples the hard-wired DCSU to a decoder, wherein the decoder interprets the display code to select a specified display instruction from a plurality of display instructions that are stored in the decoder, and wherein the specified display instruction has been pre-determined for the embedded illumination circuits.

3. The poster of claim 2, further comprising:
a light driver coupler, wherein the light driver coupler electrically and removably couples the embedded illumination circuits to a light driver, wherein the light driver receives, from the decoder, the specified display instruction for controlling an illumination pattern of the embedded illumination circuits.

4. The poster of claim 3, wherein the light driver is permanently installed in a poster frame to which the poster is removably coupled.

5. The poster of claim 1, wherein the decoder is permanently installed in a poster frame to which the poster is removably coupled.

6. The poster of claim 1, wherein the hard-wired DCSU further comprises:
a plurality of wire columns;
a plurality of wire rows, wherein intersections between wires in the wire columns and wire rows are initially electrically insulated, and wherein each row wire in the plurality of wire rows independently sends a query control signal to the wire columns; and
at least one diode that is selectively electrically connected between a specified row wire in the wire rows and a specified column wire in the wire columns, wherein non-selected wires in wire columns and wire rows remain electrically insulated, and wherein query control signals independently cause unique connector information, between the wire rows and the wire columns, to be obtained from the wire columns.

7. The poster of claim 1, wherein the hard-wired DCSU further comprises:
a plurality of wire columns;
a plurality of wire rows, wherein intersections between wires in the wire columns and wire rows are initially electrically insulated, and wherein the plurality of wire rows are grouped into selectable groups that each independently send a query control signal to the wire columns; and
at least one intersection connector that is selectively connected between a specified row wire in the wire rows and a specified column wire in the wire columns, wherein non-selected wires in wire columns and wire rows remain electrically insulated, and wherein each selectable group causes unique connector information, between the wire rows and the wire columns, to be obtained from the wire columns.

8. The poster of claim 1, wherein the poster is composed of paper.

9. The poster of claim 1, wherein the embedded electrical circuits are flexible circuits that illuminate when subjected to electricity.

10. The poster of claim 1, wherein the illumination pattern is a random illumination of different embedded illumination circuits.

11. The poster of claim 1, wherein the illumination pattern is a pre-defined sequence of illumination of the embedded illumination circuits.

12. A method of illuminating a poster that has a plurality of embedded illumination circuits, the method comprising:
receiving a display code at a decoder, wherein the display code has been hard-coded in a hard-wired Display Code Storage unit (DCSU) in the poster;
in the decoder, translating the display code into a display instruction;
transmitting the display instruction to a light driver;
in the light driver, creating a lighting sequence instruction set for the plurality of embedded illumination circuits, wherein the lighting sequence is controlled by the display instruction; and
illuminating the embedded illumination circuits in accordance with the lighting sequence instruction set.

13. The method of claim 12, wherein the decoder and the light driver are permanently installed in a poster frame to which the poster is removably connected.

14. The method of claim 13, wherein the poster and the poster frame are electrically and removably coupled by a light driver coupler and a display code coupler, wherein the light driver coupler electrically couples the light driver to the plurality of embedded illumination circuits, and wherein the display code coupler electrically couples the hard-wired DCSU to the decoder.

15. The method of claim 12, wherein the hard-wired DCSU comprises:
a plurality of wire columns;
a plurality of wire rows, wherein intersections between wires in the wire columns and wire rows are initially electrically insulated, and wherein each row wire in the plurality of wire rows independently sends a query control signal to the wire columns; and
at least one diode that is selectively electrically connected between a specified row wire in the wire rows and a specified column wire in the wire columns, wherein non-selected wires in wire columns and wire rows remain electrically insulated, and wherein query control signals independently cause unique connector information, between the wire rows and the wire columns, to be obtained from the wire columns.

16. The method of claim 12, wherein the hard-wired DCSU comprises:
a plurality of wire columns;
a plurality of wire rows, wherein intersections between wires in the wire columns and wire rows are initially electrically insulated, and wherein the plurality of wire rows are grouped into selectable groups that each independently send a query control signal to the wire columns; and
at least one intersection connector that is selectively connected between a specified row wire in the wire rows and a specified column wire in the wire columns, wherein non-selected wires in wire columns and wire rows remain electrically insulated, and wherein each selectable group causes unique connector information, between the wire rows and the wire columns, to be obtained from the wire columns.

17. The method of claim 12, wherein the embedded electrical circuits are flexible circuits that illuminate when subjected to electricity.

18. The method of claim 12, wherein the lighting sequence is a pre-defined sequence of illumination of the embedded illumination circuits.

19. A poster frame comprising:
a decoder, wherein the decoder receives a display code from a hard-wired Display Code Storage Unit (DCSU) that is embedded in a poster, said poster being removably and electrically coupled to the poster frame, and wherein the decoder translates the display code into a display instruction; and
a light driver, wherein the light driver is electrically coupled to a plurality of embedded illumination circuits in the poster, wherein the light driver creates a lighting sequence, for the plurality of embedded illumination circuits, which is controlled by the display instruction.

20. The poster frame of claim 19, wherein the hard-wired DCSU includes wire columns and wire rows, and wherein the decoder further comprises:
a row line selector that selectively signals a line in a row line to interrogate the wire rows for connections between wires in the wire columns and wires in the wire rows.
